(19) United States
(12) Patent Application Publication
(10) Pub. No.: US 2026/0340426 A1
(43) Pub. Date: Oct. 29, 2026

(54) SYSTEMS AND METHODS FOR EFFICIENT DATA SAMPLING FOR MACHINE-LEARNING APPLICATIONS

(71) Applicant: JPMORGAN CHASE BANK, N.A., New York, NY (US)

(72) Inventors: Pranav DESHPANDE, Brooklyn, NY (US); Niraj KUMAR, Amsterdam (NL); Marco PISTOIA, New York, NY (US); Abhishek SOM, Allston, MA (US)

(21) Appl. No.: 19/657,885

(22) Filed: Apr. 24, 2026

Related U.S. Application Data
(60) Provisional application No. 63/796,656, filed on Apr. 29, 2025.

(51) Int. Cl. G06N 5/01

(52) U.S. Cl. CPC G06N 5/01

(57) ABSTRACT

Systems and methods for efficient data sampling for machine learning applications are disclosed. According to an embodiment, a method may include: receiving, by a computer program, a data matrix; obtaining, by the computer program, a probability weight for each row in the data matrix; constructing, by the computer program, a sampling tree structure comprising a plurality of leaf nodes and a plurality of non-leaf nodes, wherein each leaf node of the sampling tree structure is associated with one of the probability weights, and each non-leaf node is associated with the weights of its leaf nodes; clustering, by the computer program, sampled data points using a clustering algorithm; and outputting, by the computer program, centers calculated by the clustering algorithm.

### RELATED APPLICATIONS

This application claims priority to, and the benefit of, U.S. Provisional Patent Application Ser. No. 63/796,656, filed Apr. 29, 2025, the disclosure of which is hereby incorporated, by reference, in its entirety.

### BACKGROUND OF THE INVENTION

### 1. Field of the Invention

Embodiments relate to systems and methods for efficient data sampling for machine learning applications.

### 2. Description of the Related Art

Machine learning applications often involve “Big Data” applications with millions, if not billions, of data points. Examples of machine learning applications include topic modeling, credit card fraud detection, default prediction, etc., and use generic machine learning algorithms, such as clustering and Stochastic Gradient Descent.

Many of these algorithms either go through the entire dataset to perform operations or pick samples from a dataset in a manner which is not efficient.

### SUMMARY OF THE INVENTION

Systems and methods for efficient data sampling for machine learning applications are disclosed. According to an embodiment, a method may include: receiving, by a computer program, a data matrix; obtaining, by the computer program, a probability weight for each row in the data matrix; constructing, by the computer program, a sampling tree structure comprising a plurality of leaf nodes and a plurality of non-leaf nodes, wherein each leaf node of the sampling tree structure is associated with one of the probability weights, and each non-leaf node is associated with the weights of its leaf nodes; clustering, by the computer program, sampled data points using a clustering algorithm; and outputting, by the computer program, centers calculated by the clustering algorithm.

In an embodiment, the probability weight for each row may include a norm for the weight divided by the Frobenius norm for the data matrix.

In an embodiment, the sampling tree structure may include a plurality of binary tree segments.

In an embodiment, the clustering algorithm iterates until convergence.

In an embodiment, the clustering algorithm rebalances the centers as samples are added to the centers.

In an embodiment, the computer program outputs labels for the centers.

In an embodiment, fewer than 10% of the rows in the data matrix are sampled.

In an embodiment, the square root of the number of rows in the data matrix are sampled.

In an embodiment, convergence may be achieved when the centers are within a tolerance of each other.

According to another embodiment, a non-transitory computer readable storage medium may include instructions stored thereon, which when read and executed by one or more computer processors, cause the one or more computer processors to perform steps comprising: receiving a data matrix; obtaining a probability weight for each row in the data matrix; constructing a sampling tree structure comprising a plurality of leaf nodes and a plurality of non-leaf nodes, wherein each leaf node of the sampling tree structure is associated with one of the probability weights, and each non-leaf node is associated with the weights of its leaf nodes; clustering sampled data points using a clustering algorithm; and outputting centers calculated by the clustering algorithm.

In an embodiment, the probability weight for each row may include a norm for the weight divided by the Frobenius norm for the data matrix.

In an embodiment, the sampling tree structure may include a plurality of binary tree segments.

In an embodiment, the clustering algorithm iterates until convergence.

In an embodiment, the clustering algorithm rebalances the centers as samples are added to the centers.

In an embodiment, the computer program outputs labels for the centers.

In an embodiment, fewer than 10% of the rows in the data matrix are sampled.

In an embodiment, the square root of the number of rows in the data matrix are sampled.

In an embodiment, convergence may be achieved when the centers are within a tolerance of each other.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for efficient data sampling for machine learning applications according to an embodiment;

FIG. 2 illustrates a method for efficient data sampling for machine learning applications according to an embodiment;

FIG. 3 illustrates a method for obtaining probability weights for a matrix is disclosed according to an embodiment;

FIG. 4 illustrates a method of constructing a sampling tree structure according to an embodiment;

FIG. 5 illustrates an example of a sampling tree according to an embodiment;

FIG. 6 illustrates a method for clustering according to an embodiment;

FIG. 7 illustrates an example of a sampling traversal through the tree according to an embodiment;

FIG. 8 illustrates a method of updating weights according to an embodiment;

FIG. 9 depicts an exemplary computing system for implementing aspects of the present disclosure.

### DETAILED DESCRIPTION OF PREFERRED EMBODIMENTS

Embodiments relate to systems and methods for efficient data sampling for machine learning applications.

Embodiments introduce sampling techniques into machine learning algorithms. Thus, the machine learning algorithms process only a subset of these data points, which increases processing speed and efficiency.

Embodiments sample data points such that “important” data points are sampled so that the end-to-end accuracy of the algorithm is not impacted. By processing only important data points, processing speed, efficiency, and accuracy are maintained. Specifically, the important data points may be identified based on their L2-norm, so higher-norm (more informative) rows are sampled with higher probability.

Additional technical advantages include: reduced memory consumption (fewer rows processed at a time), reduced computational cost per iteration, faster convergence of the clustering algorithm, and the ability to handle dynamic data updates efficiently via the tree update algorithm (O (log n) per update).

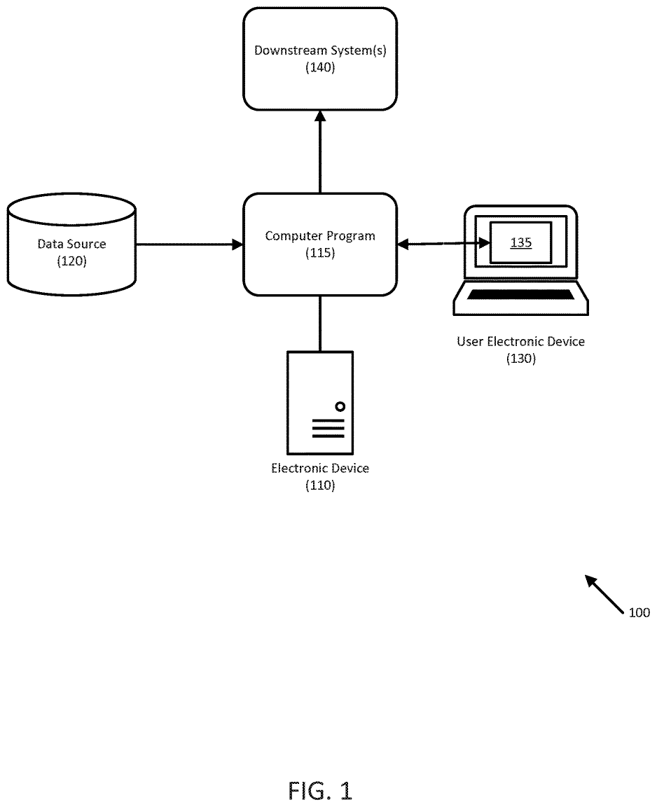

Referring to FIG. 1, a system for efficient data sampling for machine learning is disclosed according to an embodiment. System 100 may include electronic device 110, which may be a server (e.g., physical and/or cloud-based), a computer (e.g., a workstation, desktop, laptop, notebook, tablet, etc.), a smart device (e.g., smart phone, smart watch, etc.), an Internet of Things (IoT) appliance, etc.

Electronic device 110 may execute computer program 115, which may process data from data source 120, such as data that may be used for machine learning.

The computer program may process a data matrix V, having N rows and d columns, where rows represent records/data points and columns represent features. The data may include numerical values (integers, floating-point numbers) representing, for example, high-dimensional vector embeddings from speech-to-text transcriptions, credit card transaction features, customer demographic attributes, or any numerical feature data suitable for machine learning.

In one embodiment, computer program 115 may efficiently sample machine learning data from data source 120 and may provide it to one or more downstream systems 140. Downstream systems 140 may machine-learning based systems, including, for example, topic modeling systems, credit card fraud detection systems, demographic analytics systems, and recommender systems for grouping users with common interests. Downstream systems 140 may consume the cluster centers and labels output by the computer program to categorize, classify, or group data points for their respective applications.

A user may provide parameters to computer program 115 using user computer program 135 executed by user electronic device 130, such as a computer, a smart device, an IoT appliance, etc.

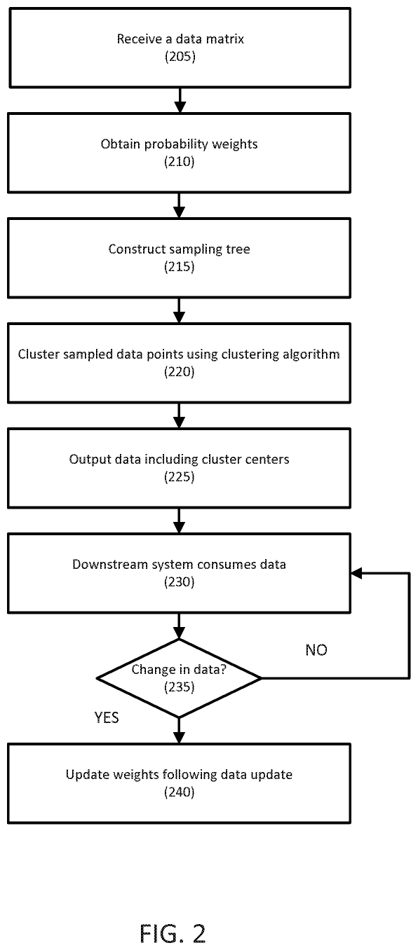

Referring to FIG. 2, a method for efficient data sampling for machine learning is disclosed according to an embodiment.

In step 205, a computer program may receive a data matrix. For example, the computer program may receive a data matrix V that may include N rows and d columns. The data matrix may include numerical data (integers or floating-point values). Each row may represent a data point/record and each column may represent a feature/dimension. The data represents feature vectors used in machine learning, such as embeddings of text, transaction attributes, or sensor readings.

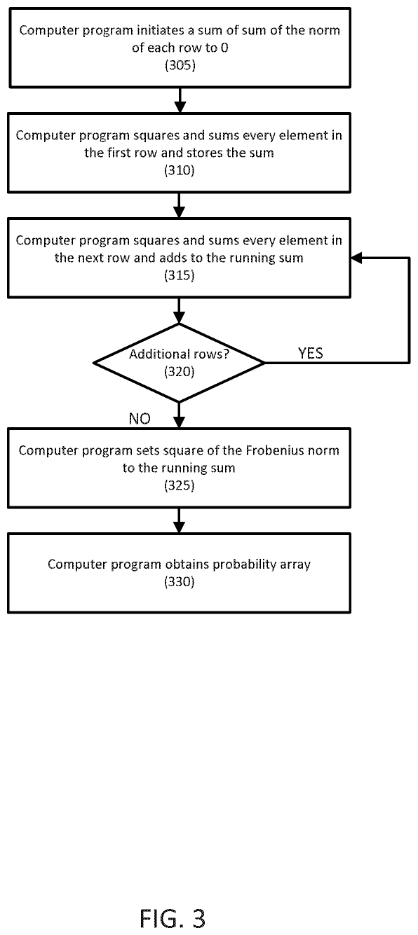

In step 210, the computer program may obtain probability weights (e.g., the row norms) for the matrix. Specifically, referring to FIG. 3, the computer program may iterate through all N rows of the data matrix. In step 305, the running sum (i.e., the sum of the norm of each row) is initiated to zero, and in step 310, for the first row, the computer program may square and sum every element of the row, and the sum is stored as the running sum. This gives a norm (i.e., Norm1, Norm2 in the example below) for the row.

In step 315, for the second row, the computer program may square and sum every element of the row, and add the sum to the running sum.

In step 320, if there are additional rows, the process may return to step 315 until all rows are processed.

If all rows are processed, in step 325, the square of the Frobenius norm is set to the running sum of all rows. The square of the Frobenius norm equals the running sum of the squared norms of all rows. The illustrative example below confirms: Frobenius norm²=5+25=30.

In step 330, the computer program may obtain a probability array by dividing the stored sum for each row by the sum of norms (i.e., the Frobenius norm) for the table. The probability array is the set of weights [w₁, w₂, . . . , wₙ], where each wᵢ=(row norm)²/(Frobenius norm²). In the illustrative example below, weights=[5/30, 25/30]=[0.1666, 0.8334].

An illustrative example is as follows:

$$MATRIX A = \{ \begin{matrix}1 & 2 \\ 3 & 4\end{matrix} \}$$

For first row: Norm1=1²+2²=5
Running sum=0+Norm1=5
For second row: Norm2=32+42=25
Running sum=Norm1+Norm2=30
Frobenius norm=running sum=30
Weights=[5, 25]/30=[0.1666, 0.8334] (Two rows, two probability weights)

Referring again to FIG. 2, in step 215, the computer program may construct a sampling tree structure having leaf nodes and non-leaf nodes. The sampling data structure may be implemented classically as a binary segment tree, which may be a collection of several binary segment trees. For example, the sampling data structure may be implemented as an array in Cython, which may leverage C functions and compile the code to machine code (first, the code is transpired to C/C++, and then compiled to a target independent code optimizer and generator, such as LLVM. Basically, instead of compiling directly to machine code, the code may be compiled to an intermediate common hyper-optimized state, then all machines can take this state and compile it as needed.

The sampling tree structure may consume an arbitrary probability distribution. For many applications, however, L2-norm sampling (or Euclidean norm sampling) may be performed; thus, the distribution may be submitted to a data structure creator for sampling from this distribution.

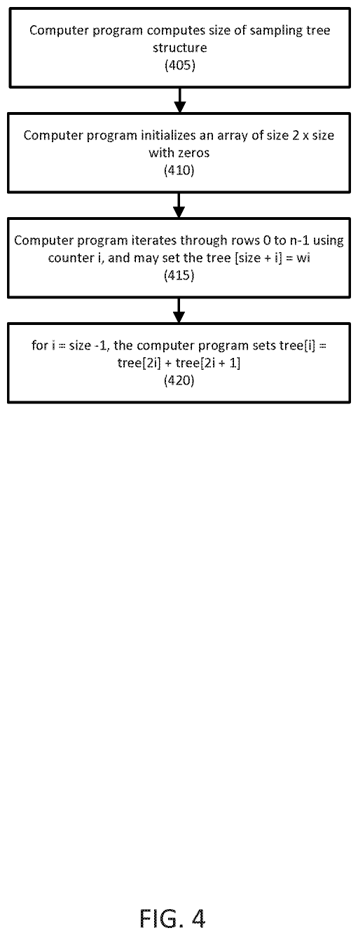

Referring to FIG. 4, using the weights (w₁, w₂, . . . , wₙ) from step 210, the computer program may construct the sampling tree structure. In step 405, the computer program may compute a size for the sampling tree structure. The size may be given by 2^{┌log}^{₂}^{n┐}.

In step 410, the computer program may initialize an array of size 2× size with zeros.

In step 415, the computer program may iterate through rows 0 to n−1 using counter i, and may set the tree[size+i]=wᵢ. The leaf nodes of the binary tree may be stored in array positions starting at index size. So, for row i (0-indexed), its weight wᵢ is placed at tree[size+i]. This places all the probability weights at the leaf level of the tree.

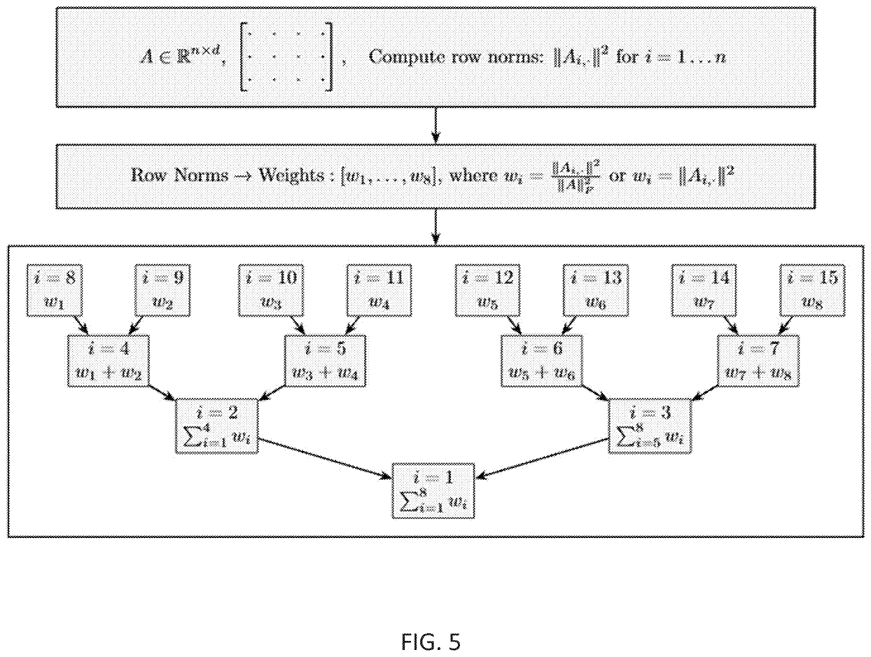

Next, in step 420, for i=size−1, the computer program may set tree[i]=tree[2i]+tree[2i+1]. This builds the internal nodes of the tree bottom-up. Each parent node stores the sum of its two children. Starting from i=size−1 down to 1, each internal node accumulates the total weight of its subtree. The root (index 1) ends up holding the total sum of all weights. This is illustrated in FIG. 5, where, for example, node i=4 holds w₁+w₂ and the root i=1 holds the sum of all eight weights.

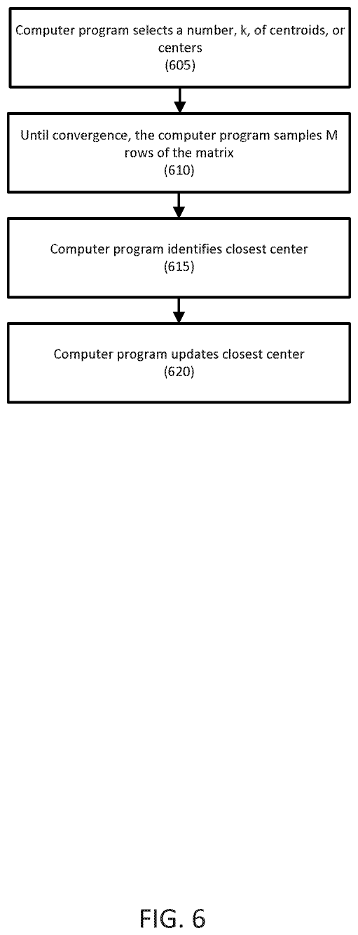

Referring again to FIG. 2, in step 220, the computer program may execute a clustering algorithm. Referring to FIG. 6, a method for clustering is provided according to an embodiment.

In step 605, the computer program may select a number, k, of centroids, or centers. The number k may be received as a parameter.

In one embodiment, the number k may be a user-supplied parameter. The initial k centroids may be selected randomly from the data matrix rows, or using an initialization heuristic. The algorithm may selects k initial centroids c₁⁰, . . . , cₖ⁰ and may initialize counters N₁, . . . , Nₖ to 0.

In step 610, until convergence, the computer program may sample M rows of the matrix. M is the number of rows sampled per iteration (e.g., at t=0, M rows sampled, t=1, M rows sampled, etc.). A second counter (b) is provided for rebalancing (discussed below). M may be received as a parameter.

In one embodiment, M may be less than 1/10 of the number of rows in the matrix. For example, M may be 1/100 of the rows in the matrix, or even equal to the square root of the number of rows in the matrix when the matrix is very large (e.g., over 100 million rows).

The sampling may identify the important points based on the L2 distribution. A higher norm indicates a higher importance of the row. During the creation process, the tree follows the property that value of parent equals the sum of values of the children, thus, when a random number between 0 and the sum of the weights array is selected, the process searches through the tree (e.g., is current node less or greater than sampled r as shown in the diagram, go left or right depending on the result). Tree [2×index] references one child, and Tree[2×index+1] references the other child. Once a leaf node is reached, the leaf node is returned.

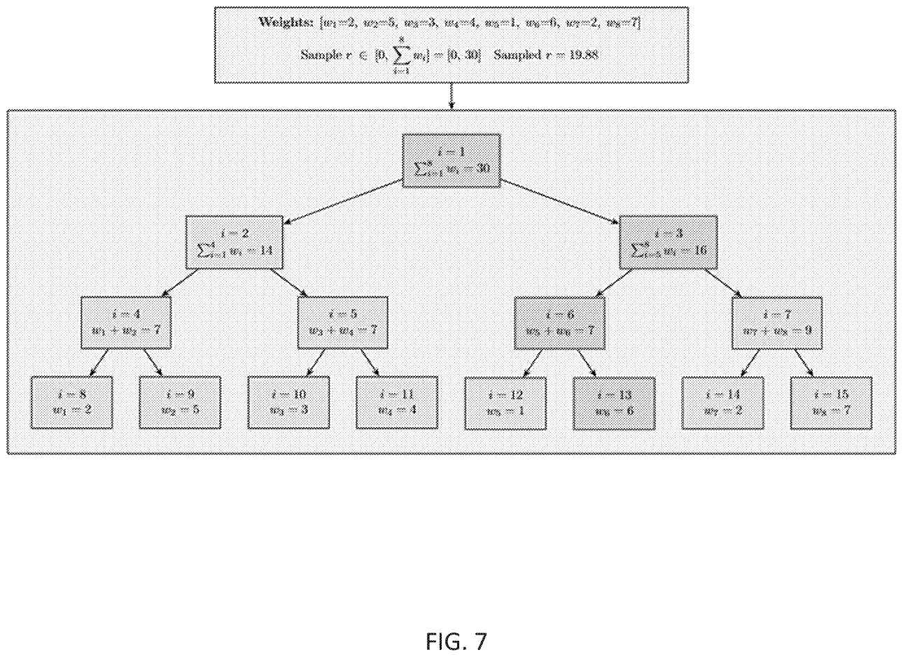

FIG. 7 illustrates an example of a sampling traversal through the tree. It illustrates how a random number r=19.88 is sampled and the tree is traversed (comparing r against left-child values to decide left versus right) until a leaf node is reached.

Referring again to FIG. 6, in step 615, the computer program may identify the closest center. For example,

$$l ← arg {min}_{j ∈ [ k ] ‖ {c}_{j}^{t} - {v}_{{i}_{b}}^{t} ‖} .$$

This identifies the closest center to the sampled data point. For each sampled row vi, and the distance to every center cⱼ is computed, and the center, cₗ, with the minimum distance is selected.

In step 620, the computer program may update the center. For example,

$${c}_{l}^{t = 1} ← {c}_{l}^{t} - \frac{1}{{N}_{i}} \cdot ( {c}_{l}^{t} - {v}_{{i}_{b}}^{t} ) .$$

This incrementally adjusts the closest center:

$${c}_{l}^{t + 1} = {c}_{l}^{t} - ( 1 / {N}_{l} ) \cdot ( {c}_{l}^{t} - {v}_{i} ) .$$

This is an online/incremental mean update—it moves the center slightly toward the new data point, weighted by 1/Nₗ where Nₗ is the count of points assigned to that center.

Convergence may be achieved when the centers are within a pre-specified tolerance of each other. For example, for example iteration i and iteration i+1 have a minimal distance between their centers as 1e-4. The tolerance may be supplied during the run as is necessary and/or desired.

In step 225, the computer program may output data, including the centers and labels for all the points. A label may identify the center each point belongs to. For example, given a dataset of diabetic and non-diabetic people, diabetics might be labelled center 0 and the others center 1.

In step 230, a downstream system may consume the data. Downstream systems may include any system that may use clustering, such as topic modeling systems, credit card fraud detection systems, demographic analytics systems, recommender systems for grouping users with common interests, etc.

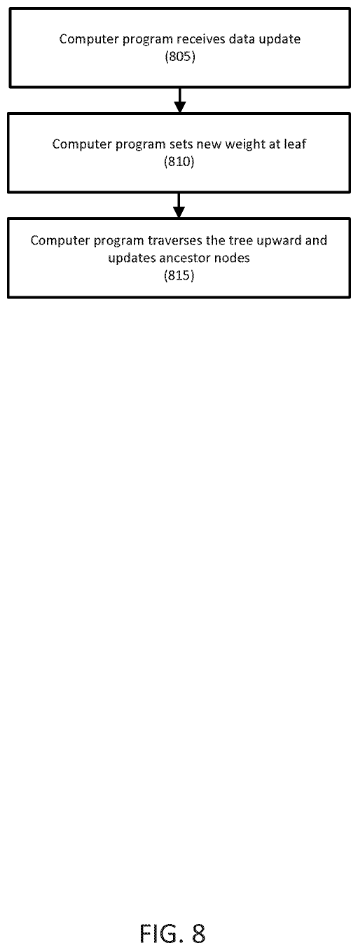

In step 235, if the data changes, in step 240, the weights may be updated. Referring to FIG. 8, a method of updating weights is disclosed according to an embodiment.

In step 805, the computer program may receive a data update. In one embodiment, the data update may be for a subset of the data, such as when individual rows change, are added, or are removed. The update process modifies only the affected leaf and propagates changes up the tree in O(log n) time, rather than rebuilding the entire structure.

In step 810, the computer program may set a new weight at leaf of the sampling tree.

In step 815, after setting the new weight at the leaf (tree[size+i]=new_weight), the computer program traverses the tree upward from j=(size+i)/2 down to 1, updating each ancestor node as tree[j]=tree[2j]+tree[2j+1]. This propagates the weight change from the leaf to the root, maintaining the property that each parent equals the sum of its children.

The size is the number of elements stored as the next power of 2 for ease of storage. For example, if number of rows is 15, then the number of norms is 15, and the size of the tree=2^{(ceiling(log 15)}=2⁴=16.

For example, for any new rows, step 810 may be processed and added to the tree using this algorithm.

Embodiments may accelerate several machine learning and linear algebra tasks by a multiplicative factor while maintaining similar accuracy to existing state of the art algorithms.

An illustrative, non-limiting example of a use case includes topic modelling. Organizations receive many voice calls from customers each week. It is not possible for even thousands of analysts to manually analyze these voice calls. Thus, the voice calls may be transcribed using a Speech to Text Model or service, may be converted to embeddings (e.g., high-dimensional vectors that can be “understood” by machine learning models), and then clustered using the process described above. The “centers,” which are numerical embeddings, may be converted back to natural language, providing the most important topics that customers called regarding.

In embodiments, gradient descent and solving systems of linear equations may also be accelerated using the sampling process described herein. Stochastic Gradient Descent (SGD) is a learning algorithm used in Deep Learning to train AI Models. In technical terms, it is used to minimize the loss function and improve model performance. It is a variant of the traditional gradient descent algorithm, which aims to find the optimal parameters of a model by iteratively updating them in the direction that reduces the loss.

The key difference between SGD and traditional gradient descent is how they compute the gradient. In traditional gradient descent, the gradient is calculated using the entire dataset, which can be computationally expensive and slow, especially for large datasets.

In contrast, SGD approximates the gradient by using only a single data point (or a small batch of data points) at each iteration. This makes SGD much faster and more efficient, particularly for large-scale datasets. The use of a single data point, however, introduces noise into the gradient estimation, which can lead to fluctuations in the optimization path.

The sampling algorithm described above may be used to sample points and may make the process converge faster.

The Kaczmarz algorithm (Kaczmarz, Stefan, “Angenäherte Auflösung von Systemen linearer Gleichungen” Bulletin International de l'Académie Polonaise des Sciences et des Lettres. Classe des Sciences Mathématiques et Naturelles, Série A, Sciences Mathématiques, vol. 35, pp. 355-357 (1937), the disclosure of which is incorporated by reference in its entirety) is an iterative method used to solve systems of linear equations, particularly useful for large and sparse systems. The sampling algorithm described above may be used to accelerate the Kaczmarz algorithm by sampling subsets of the points in the linear system of equations, and then solving those.

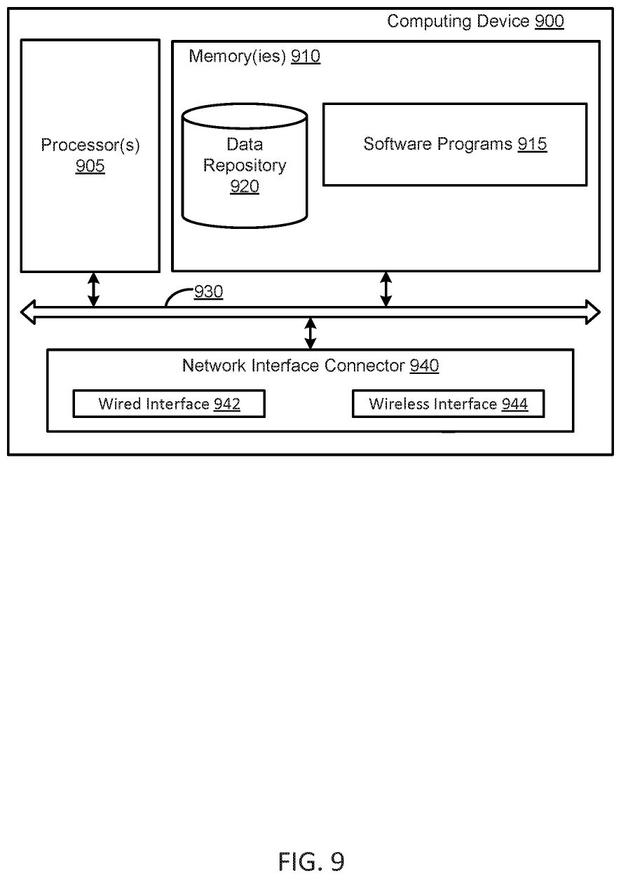

FIG. 9 depicts an exemplary computing system for implementing aspects of the present disclosure. FIG. 9 depicts exemplary computing device 900. Computing device 900 may represent the system components described herein. Computing device 900 may include processor 905 that may be coupled to memory 910. Memory 910 may include volatile memory. Processor 905 may execute computer-executable program code stored in memory 910, such as software programs 915. Software programs 915 may include one or more of the logical steps disclosed herein as a programmatic instruction, which may be executed by processor 905. Memory 910 may also include data repository 920, which may be nonvolatile memory for data persistence. Processor 905 and memory 910 may be coupled by bus 930. Bus 930 may also be coupled to one or more network interface connectors 940, such as wired network interface 942 or wireless network interface 944. Computing device 900 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

1. A method, comprising:
receiving, by a computer program, a data matrix;
obtaining, by the computer program, a probability weight for each row in the data matrix;
constructing, by the computer program, a sampling tree structure comprising a plurality of leaf nodes and a plurality of non-leaf nodes, wherein each leaf node of the sampling tree structure is associated with one of the probability weights, and each non-leaf node is associated with the weights of its leaf nodes;
clustering, by the computer program, sampled data points using a clustering algorithm; and
outputting, by the computer program, centers calculated by the clustering algorithm.

2. The method of claim 1, wherein the probability weight for each row comprises a norm for the weight divided by the Frobenius norm for the data matrix.

3. The method of claim 1, wherein the sampling tree structure comprises a plurality of binary tree segments.

4. The method of claim 1, wherein the clustering algorithm iterates until convergence.

5. The method of claim 1, wherein the clustering algorithm rebalances the centers as samples are added to the centers.

6. The method of claim 1, wherein the computer program outputs labels for the centers.

7. The method of claim 1, wherein fewer than 10% of the rows in the data matrix are sampled.

8. The method of claim 1, wherein a square root of a number of rows in the data matrix are sampled.

9. The method of claim 1, wherein convergence is achieved when the centers are within a tolerance of each other.

10. A non-transitory computer readable storage medium, including instructions stored thereon, which when read and executed by one or more computer processors, cause the one or more computer processors to perform steps comprising:
receiving a data matrix;
obtaining a probability weight for each row in the data matrix;
constructing a sampling tree structure comprising a plurality of leaf nodes and a plurality of non-leaf nodes, wherein each leaf node of the sampling tree structure is associated with one of the probability weights, and each non-leaf node is associated with the weights of its leaf nodes;
clustering sampled data points using a clustering algorithm; and
outputting centers calculated by the clustering algorithm.

11. The non-transitory computer readable storage medium of claim 10, wherein the probability weight for each row comprises a norm for the weight divided by the Frobenius norm for the data matrix.

12. The non-transitory computer readable storage medium of claim 10, wherein the sampling tree structure comprises a plurality of binary tree segments.

13. The non-transitory computer readable storage medium of claim 10, wherein the clustering algorithm iterates until convergence.

14. The non-transitory computer readable storage medium of claim 10, wherein the clustering algorithm rebalances the centers as samples are added to the centers.

15. The non-transitory computer readable storage medium of claim 10, further including instructions stored thereon, which when read and executed by the one or more computer processors, cause the one or more computer processors to outputs labels for the centers.

16. The non-transitory computer readable storage medium of claim 10, wherein fewer than 10% of the rows in the data matrix are sampled.

17. The non-transitory computer readable storage medium of claim 10, wherein a square root of a number of rows in the data matrix are sampled.

18. The non-transitory computer readable storage medium of claim 10, wherein convergence is achieved when the centers are within a tolerance of each other.
